(19) United States
(12) Patent Application Publication
(10) Pub. No.: US 2022/0035227 A1
(43) Pub. Date: Feb. 3, 2022

(54) CURVED SOFT BOX

(71) Applicant: Adorama Camera, Inc., New York, NY (US)

(72) Inventor: Joseph Mendlowits, New York, NY (US)

(73) Assignee: Adorama Camera, Inc., New York, NY (US)

(21) Appl. No.: 16/940,978

(22) Filed: Jul. 28, 2020

(51) Int. Cl. G03B 15/07; F21V 7/18; F21V 7/24; F21V 7/07

(52) U.S. Cl. CPC G03B 15/07; F21V 7/07; F21V 7/24; F21V 7/18

(57) ABSTRACT

A softbox may include a housing, a light mount and a light diffuser screen that covers an opening formed in the housing. The light diffuser screen may have a curved shape in some cases. In other cases, a light diffuser screen may not be used but the perimeter of the housing opening may be non-planar.

### I. BACKGROUND

### A. Field of the Invention

This invention generally relates to methods and apparatuses related to photography and more specifically to methods and apparatuses related to softboxes.

### B. Description of Related Art

A softbox is a type of photographic lighting device. Typically, a softbox includes an enclosure or housing, having interior light reflective surfaces, that receives light from an internal light source and emanates the light through a light diffuser panel or screen. A softbox diffuses the light into a pleasing soft, even light and, when used properly, reduces harsh shadows.

Softbox diffuser screens are have various shapes and sizes. Known diffuser screen shapes include rectangles (see FIG. 17) and octagons (see FIG. 18). While known softboxes generally work well for their intended purposes, they have limitations. One limitation is due to the fact that known diffuser screens are planar. The light emanating from known softboxes thus has varying degrees of intensity. As a result, they do not gracefully blend light in the face of a subject or create a gentle catchlight.

Another known type of photographic lighting device is a reflective panel (see FIG. 19). While known reflective panels generally work well for their intended purposes, they have limitations. One limitation is that they do not generate light. As a result, they cannot be used as a sole modifier. Another limitation is that reflective panels often require proximity to the subject that is uncomfortable.

What is needed is a softbox with a curved diffuser screen and/or curved outlet opening to simultaneously overcome the limitations of known softboxes and the limitations of known reflective panels. This invention will provide numerous other advantages as will be readily understood by a person of skill in the art.

### II. SUMMARY

According to some embodiments of this invention, a softbox may include: a housing having: a bottom; wall structure extending from the bottom to a distal end; and an opening having a perimeter defined by the distal end of the wall structure; and a light mount that: is supported to the bottom; is designed to attach to an associated light source including a lamp positioned at least partially within the housing; and has a longitudinal axis. A bottom plane may be defined as a plane that: is perpendicular to the longitudinal axis of the light mount; and intersects the bottom of the housing farthest from the perimeter. A first point may lie on the perimeter closest to the bottom plane. A second point may lie on the perimeter farthest from the bottom plane. A first point plane may be defined as a plane that intersects the first point and is parallel to the bottom plane. A second point plane may be defined as a plane that intersects the second point and is parallel to the bottom plane. The first and second point planes may be separated by a distance D1 that is at least 3 inches.

According to some embodiments of this invention, a softbox may include: a housing having: a bottom; wall structure extending from the bottom to a distal end; and an opening having a perimeter defined by the distal end of the wall structure; a light mount that: is supported to the bottom; and is designed to attach to an associated light source including a lamp positioned at least partially within the housing; and a light diffuser screen that is supported to the housing and includes an opening cover portion that covers at least most of the opening. When the light diffuser screen is properly supported to the housing: 1) the opening cover portion of the light diffuser screen may diffuse light passing out through the opening cover portion; and 2) the opening cover portion of the light diffuser screen may have a curved shape.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective side view of a softbox according to some embodiments of this invention.

FIG. 2 is a perspective top view of a softbox according to some embodiments of this invention.

FIG. 3 is a perspective bottom view of a softbox according to some embodiments of this invention

FIG. 4 is a top view of a softbox according to some embodiments of this invention.

FIG. 5 a bottom view of a softbox according to some embodiments of this invention.

FIG. 6 is a side view of a softbox according to some embodiments of this invention.

FIG. 7 is a side view of a softbox according to some embodiments of this invention.

FIG. 8 is an end view of a softbox according to some embodiments of this invention.

FIG. 9 is a perspective top view of a softbox without a light diffuser screen according to some embodiments of this invention.

FIG. 10 is a perspective bottom view of a light mount with the light source removed for clarity according to some embodiments of this invention.

FIG. 11 is a perspective top view of a light mount, light source and latching mechanism according to some embodiments of this invention.

FIG. 12 is a perspective top view of a latching mechanism being used to lock the housing into an open use position according to some embodiments of this invention.

FIG. 13 is a perspective top view of a latching mechanism being used to unlock the housing permitting the housing to be folded according to some embodiments of this invention.

FIG. 14 is a close-up view of a frame member attached to a wall structure with a clasp according to some embodiments of this invention.

FIG. 15 is a perspective top view of a latching mechanism and a reversable deflector disk according to some embodiments of this invention.

FIG. 16A shows separated and detached softbox components according to some embodiments of this invention.

FIG. 16B shows softbox components within packaging according to some embodiments of this invention.

FIG. 17 shows a prior art softbox.

FIG. 18 shows a prior art softbox.

FIG. 19 shows a prior art reflective panel.

### IV. DETAILED DESCRIPTION

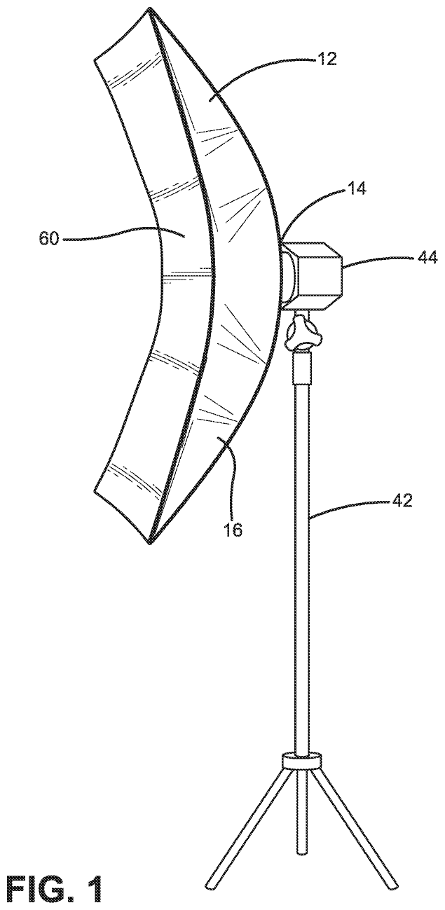

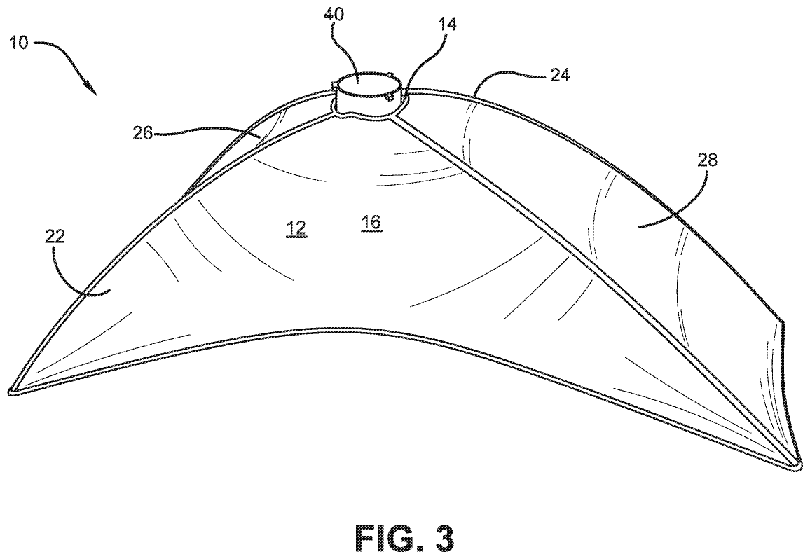

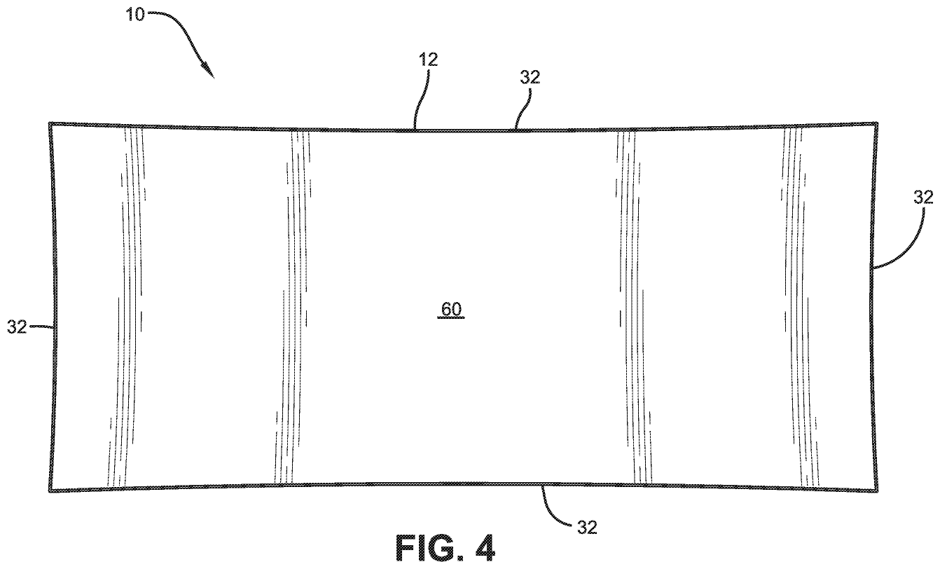

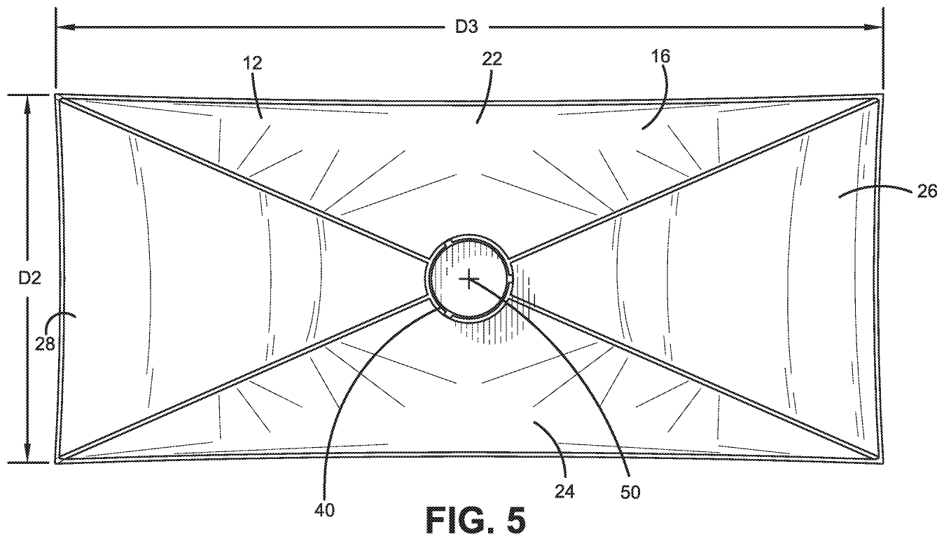

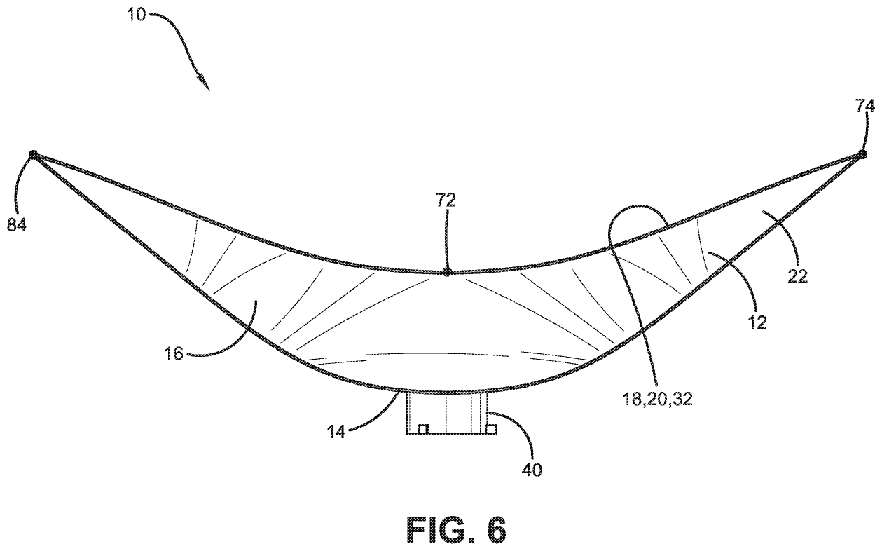

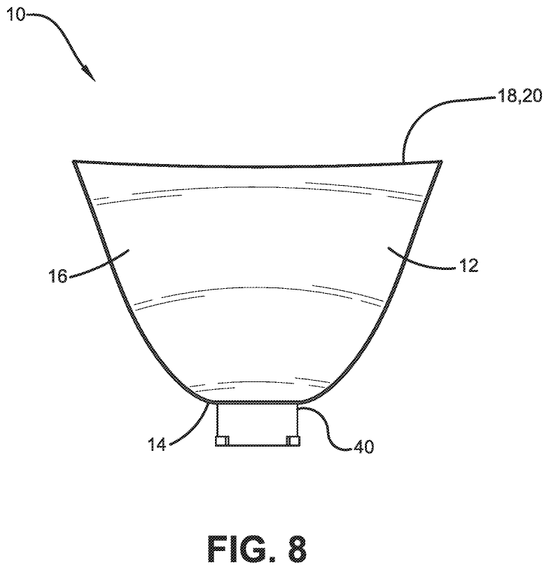

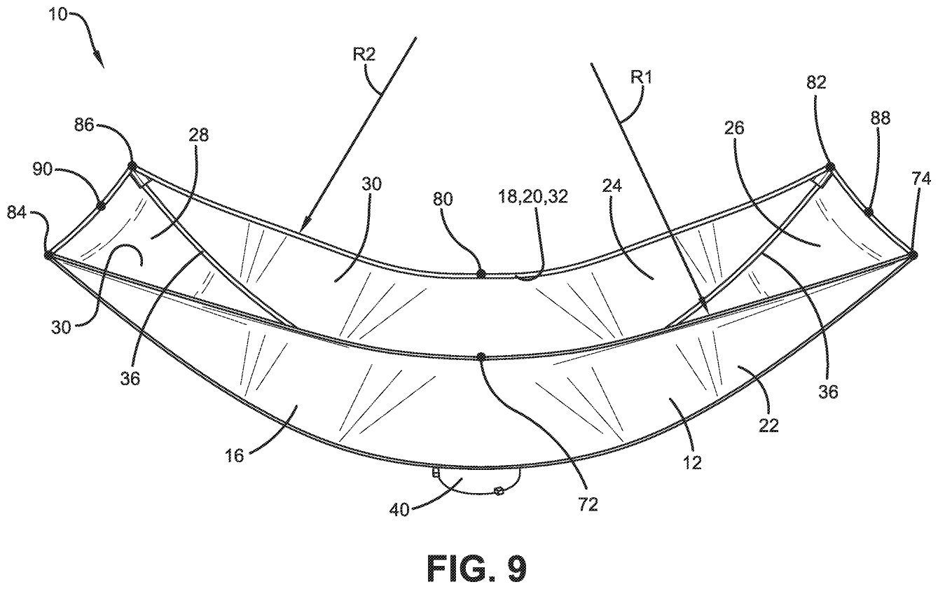

Referring now to the drawings wherein the showings are for purposes of illustrating embodiments of the invention only and not for purposes of limiting the same, and wherein like reference numerals are understood to refer to like components, FIGS. 1-9 show a softbox 10 having a housing 12 formed of a bottom 14 and a wall structure 16 extending from the bottom 14 to a distal end 18. A light outlet opening 20 may have a perimeter 32 defined by the distal end 18, as shown. While the wall structure 16 can have any design chosen with the sound judgement of a person of skill in the art, for the embodiments shown, the wall structure 16 may include, as indicated in FIGS. 3 and 5, a first side wall 22, a second side wall 24 opposite the first side wall 22, a first end wall 26 and a second end wall 28 opposite the first end wall 26. In some embodiments, shown, the side walls 22, 24 are mirror images and the end walls 26, 28 are mirror images. The interior surface 30, see FIG. 9, of the wall structure 16 may be formed of a light reflective material. The exterior surface may have a dark color.

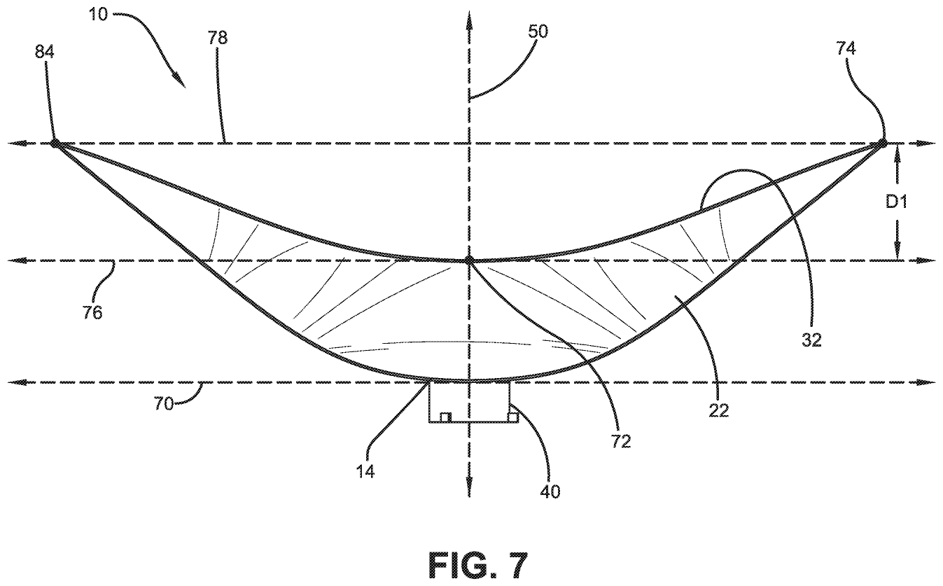

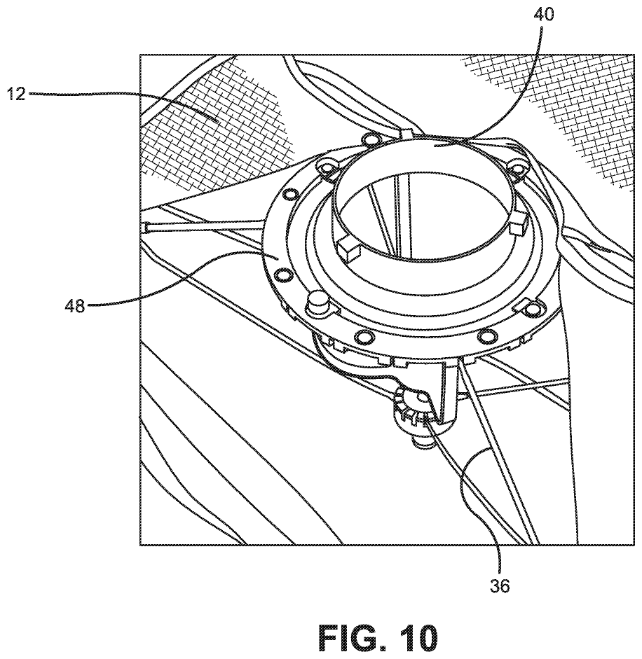

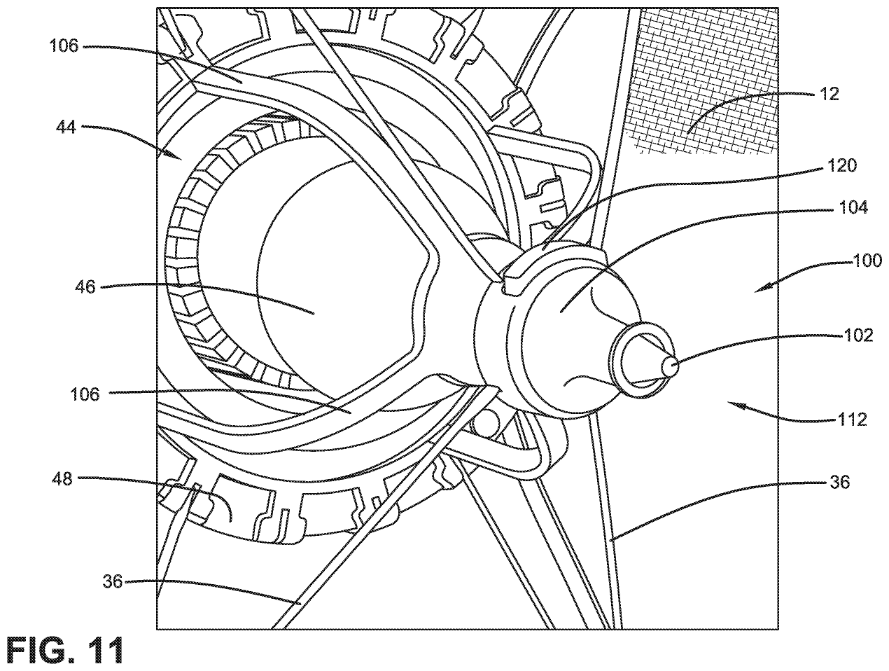

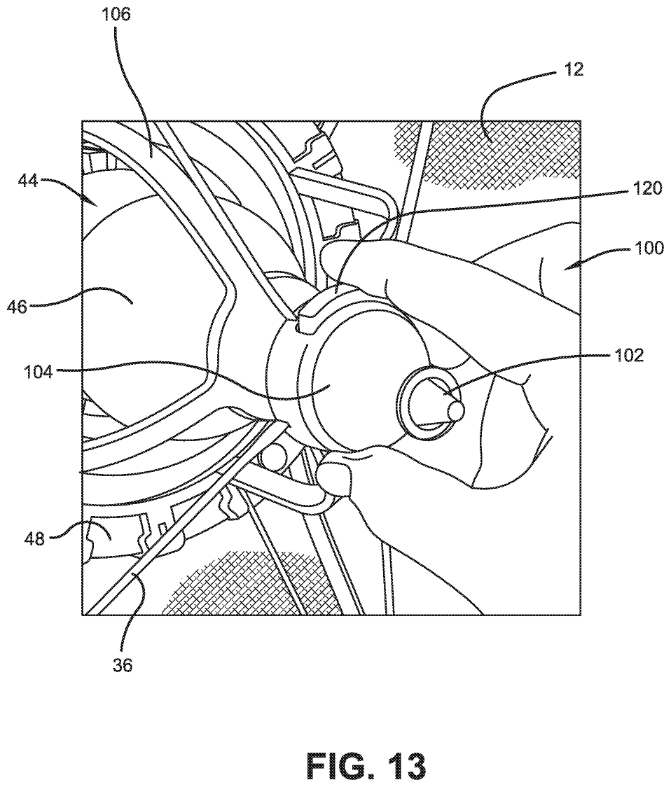

With reference now to FIGS. 1-3, 5-11 and 13, the softbox 10 may include a light mount 40 that is supported to the bottom 14 of the housing 12 and that has a longitudinal axis 50 (referenced in FIGS. 5 and 7). In some embodiments, the light mount 40 may be supported to the bottom 14 of the housing 12 via a support ring 48 (see FIG. 10). The light mount 40 may be designed to attach to a light source 44 including a lamp 46 (shown in FIGS. 11 and 13) that is positioned at least partially within the housing 12. In some embodiments, shown in FIG. 1, a support structure 42 may be used to support the light source 44 and softbox 10 to a floor or ground surface in a known manner. In some embodiments, shown, the light mount 40 may be a Bowens mount though any light mount 40 chosen with the sound judgement of a person of skill in the art may be used with various embodiments of this invention. The light source 44 may also be of any type chosen with the sound judgement of a person of skill in the art. As known to those of skill in the art, some light emanates directly from the lamp 46 out through the opening 20 while other light from the lamp 46 reflects off of the interior surface 30 of the wall structure 16 and then through the opening 20.

With reference now to FIGS. 1-2, 4 and 16A, the softbox 10 may include a light diffuser screen 60 that diffuses light that passes through it. The light diffuser screen 60 may be supported to the housing 12 and may include an opening cover portion that covers at least most of the opening 20. In some embodiments, shown, the light diffuser screen 60 covers all or virtually all of the opening 20. In this way, the light diffuser screen 60 diffuses light passing out through the opening 20. The light diffuser screen 60 may be formed of any material chosen by the sound judgement of a person of skill in the art and may be supported to the housing 12 in any manner chosen by the sound judgement of a person of skill in the art. In some embodiments, the light diffuser screen 60 may be formed of a fabric and may be selectively attachable to (and detachable from) the housing 12. In some embodiments, this selective attachment may be achieved using hook and loop fasteners.

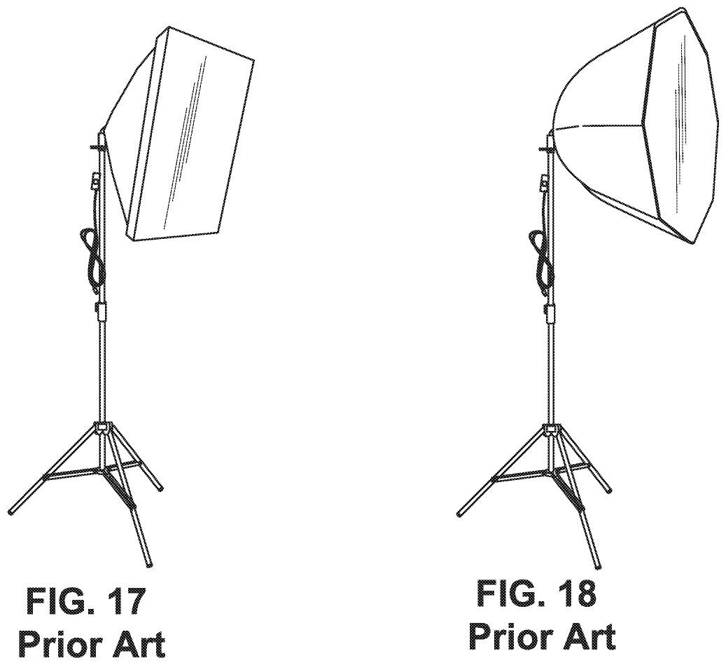

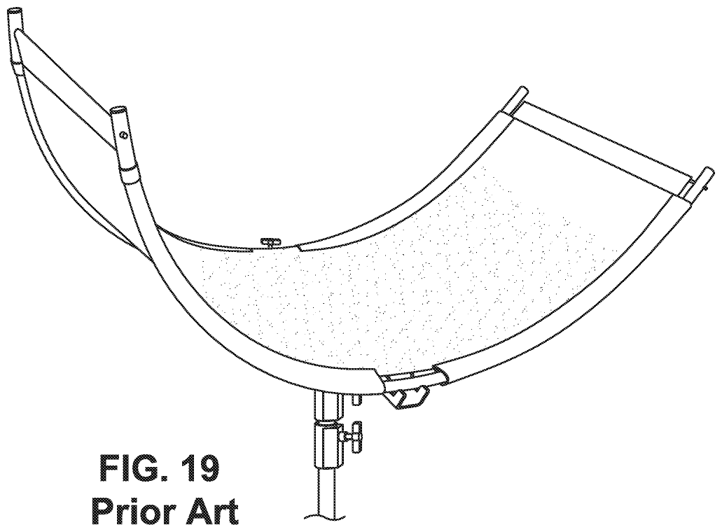

Note that whereas prior art softbox opening perimeters are planar and their diffuser screens are planar where they cover the softbox openings, (see FIGS. 17-18), the perimeter 32 and the opening cover portion of the light diffuser screen 60 of this invention have a curved shape (see FIGS. 1-2, 6 and 9). With reference particularly to FIG. 7, a bottom plane 70 is defined as a plane that: is perpendicular to the longitudinal axis 50 of the light mount 40 and intersects the bottom 14 of the housing 12 farthest from the perimeter 32. Various points on the perimeter 32 and the diffuser screen 60 as compared to the bottom plane 70 will now be described.

With reference now to FIG. 7, in some embodiments, a point 72 may be on the perimeter 32 closest to the bottom plane 70 and a point 74 may be on the perimeter 32 farthest from the bottom plane 70. A point plane 76 may be defined as a plane that intersects point 72 and is parallel to the bottom plane 70. A point plane 78 may be defined as a plane that intersects the point 74 and is parallel to the bottom plane 32. The point planes 76, 78 may be separated by a distance D1. In some embodiments, distance D1 is at least 3 inches. In other embodiments, distance D1 is at least 5 inches. In yet other embodiments, D1 is at least 7 inches. In yet other embodiments, D1 is about 8 inches (20 centimeters). With reference now also to FIG. 9, in some embodiments, point 72 is at a first location on side wall 22 and point 74 is at a second location on the side wall 74.

With reference now to FIGS. 7 and 9, in some embodiments, a point 80 may be at a first location on the second side wall 24 and may lie on point plane 76. In some embodiments, a point 82 may be at a second location on the second side wall 24 and may lie on point plane 78. In some embodiments, a point 84 may be at a third location on the first side wall 22 and may lie on point plane 78. Point 72 may be positioned between points 74 and 84, as shown. In some embodiments, a point 86 may be at a third location on the second side wall 24 and may lie on point plane 78. Point 80 may be positioned between paints 82 and 86, as shown. In some embodiments, a point 88 may be on the end wall 26 and may lie on point plane 78. In some embodiments, a point 90 may be on the end wall 28 and may lie on point plane 78. In some embodiments, the perimeter 32 along the end wall 26, including but not limited to points 74, 82 and 88, may lie on point plane 78. In some embodiments, the perimeter 32 along the end wall 28, including but not limited to points 84, 86 and 90, may lie on point plane 78.

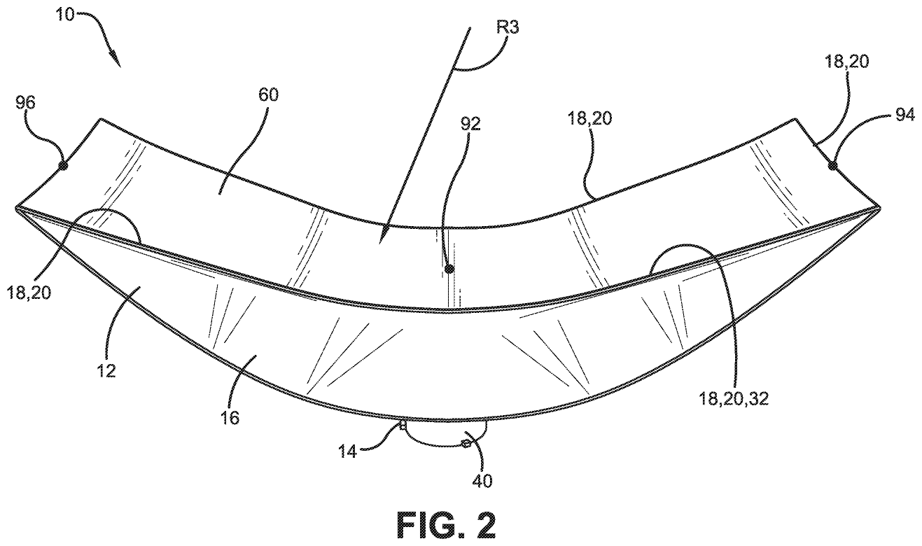

With reference now to FIGS. 2 and 7, in some embodiments, a point 92 on the light diffuser screen 60 may be closest to the bottom plane 70 and may lie on point plane 76. In some embodiments, a point 94 on the light diffuser screen 60 may lie on point plane 78. In some embodiments, a point 96 on the light diffuser screen 60 may lie on point plane 78. Point 92 may be positioned between points 94 and 96, as shown. In some embodiments, shown, the light diffuser screen 60 may follow the perimeter 32 such that the light diffuser screen 60 lies on the same planes as the corresponding perimeter 32. Thus, for example, by comparing FIG. 2 with FIG. 9 in light of FIG. 7, point 92 like points 72 and 80 may lie on point plane 76. Similarly, point 94 may be coincident with point 88 and point 96 may be coincident with point 90. Furthermore, in these embodiments, points 74, 82, 88, 84, 86, 90, 94 and 96 may all lie on plane 78.

With reference now to FIGS. 1-3, 6-7, and 9, the light diffuser screen 60 as well as the perimeter 32 of the opening 20 on side walls 22 and 24 may have curved shapes, that is, lie on a curved surface. In some embodiments, shown, the curved shape may be concave. In some embodiments, see FIG. 9, the perimeter 32 along side wall 22 may lie on an arc that lies on a circle having radius R1. In some embodiments, the perimeter 32 along side wall 24 may lie on an arc that lies on a circle having radius R2. In some embodiments, see FIG. 2, the light diffuser screen 60 may lie on an arc that lies on a circle having radius R3. In some embodiments, radius R1 equals radius R2. In some embodiments, radius R3 equals at least one of radius R1 or radius R2. In some embodiments, radii R1, R2 and R3 are the same.

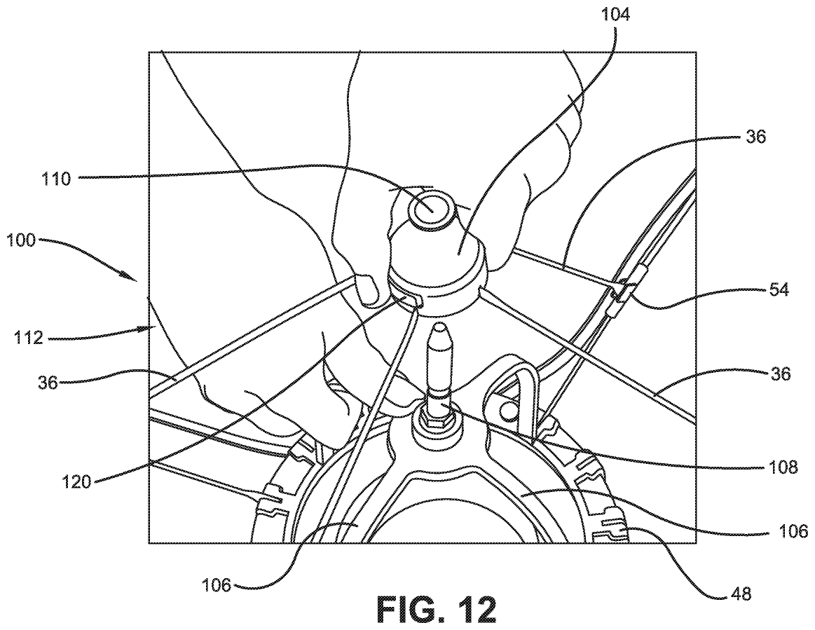

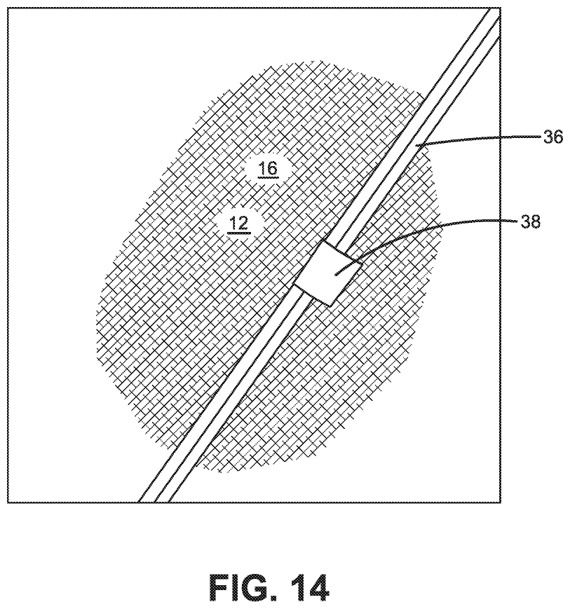

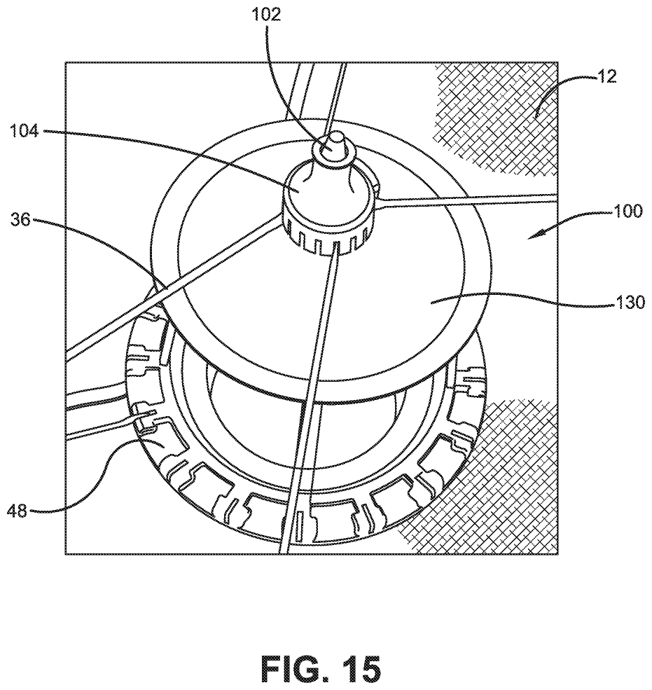

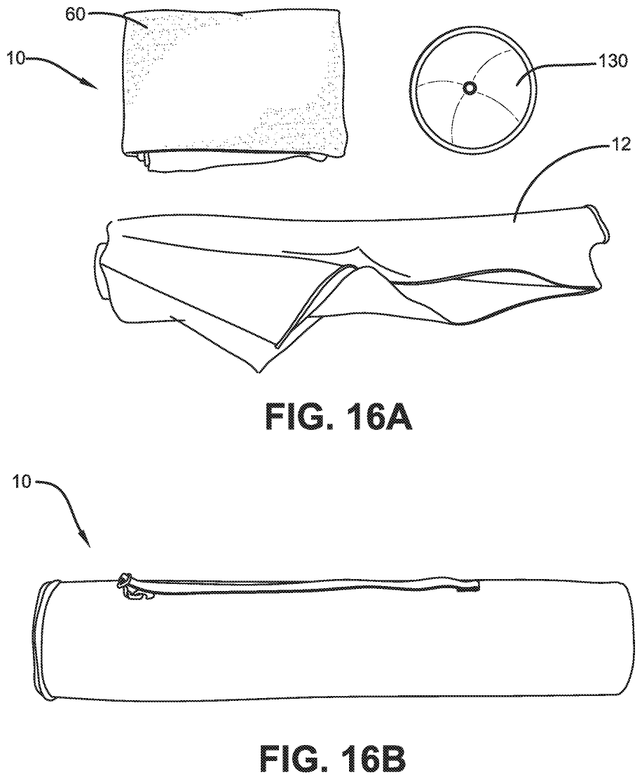

With reference now to FIGS. 9-15 and 16A, the housing 12 may be supported to a frame including frame members 36. Some of the frame members 36 may be supported to the housing 12 at locations using clasps 38 (shown in FIG. 14). Some frame members 36 may be movable relative to other frame members 36 using hinges 54 (shown in FIG. 12). In some embodiments, the housing 12 may be manually adjusted between an open use position (shown, for example, in FIG. 9) and a folded position (shown in FIG. 16A). In some embodiments, a latching mechanism 100 may be selectively manually adjustable between a first condition (shown in FIG. 11) that locks the housing 12 in an open use position (shown in FIG. 13) and a second condition that permits the housing 12 to be folded. The latching mechanism 100 and its operation will be discussed below.

With reference now to FIGS. 10-13, in some embodiments, the latching mechanism 100 may include a latch post 102 and a latch post receiver 104. The latch post 102 may be supported to the housing 12. In some embodiments, the latch post 102 is supported to the housing 12 via support legs 106 that attach to the support ring 48. The latch post 102 may be generally cylindrical in shape and may have a groove 108 on its outer surface (shown in FIG. 12). The latch post receiver 104 may be supported to some of the frame members 36, as shown. The latch post receiver 104 may have an opening 110 sized and shaped to receive the latch post 102. The latch post receiver 104 may have a latch post engagement device 112 operatively engaged to a quick-release button 120.

With reference now to FIGS. 9-13 and 16A, in some embodiments, to adjust the latching mechanism 100 out of the first condition shown in FIG. 11, the user simply presses the quick-release button 120 as shown in FIG. 13. This may cause a surface of the latch post engagement device 112 to come out of contact with the latch post groove 108. This then allows the user to separate the latch post receiver 104 from the latch post 102 as shown in FIG. 12. The user can then easily collapse/fold the housing 12 into the folded position shown in FIG. 16A. In some embodiments, to adjust the housing 12 from the folded position shown in FIG. 16A to the open use position shown in FIG. 9, the user first unfolds the housing 12. The user may then move the latch post receiver 104 toward the latch post 102 as shown in FIG. 12 such that the opening 110 in the latch post receiver 104 receives the latch post 102. This may cause a surface of the latch post engagement device 112 to come into contact with the latch post groove 108 (this motion may be accomplished automatically with a biasing device such as a spring) causing the latch post receiver 104 to engage/latch/lock with the latch post 102, holding/latching/locking the housing 12 in the open use position shown in FIG. 9.

With reference now to FIG. 5, while the actual dimensions of the softbox 10 according to this invention can be any chosen with the sound judgement of a person of skill in the art, in some embodiments, shown the perimeter of the housing 12 may have a rectangular shape. The softbox 10 may have a width D2 and a length D3. One set of dimensions found to work well are when width D2 is 40 centimeters (about 15.8 inches) and length D3 is 59 centimeters (about 23.2 inches).

FIG. 16A shows some embodiments of a softbox 10 including housing 12 (in a folded condition) and light diffuser screen 60 (also in a folded condition). In some embodiments, an optional reversible deflector disk 130, which may be used in a manner known to those of skill in the art, may be included with the softbox 10. FIG. 16B shows all the components of the softbox 10 of FIG. 16A positioned within a carrying case for easy transport.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby unconditionally reserved

Having thus described the invention, it is now claimed:

1. A softbox comprising:
a frame having multiple elongated frame members;
a housing having: a bottom; wall structure extending from the bottom to a distal end; and an opening having a perimeter defined by the distal end of the wall structure;
a light mount that: includes a Bowens mount or the like; is supported to the bottom; is designed to attach to an associated light source; and has a longitudinal axis;
wherein:
at least some of the elongated frame members: have ends that are supported to the Bowens mount or the like; extend distally along the housing wall structure; and support the housing wall structure to the Bowens mount or the like;
a bottom plane is defined as a plane that: is perpendicular to the longitudinal axis of the light mount; and intersects the bottom of the housing farthest from the perimeter;
a first point is on the perimeter closest to the bottom plane;
a second point is on the perimeter farthest from the bottom plane;
a first point plane is defined as a plane that intersects the first point and is parallel to the bottom plane;
a second point plane is defined as a plane that intersects the second point and is parallel to the bottom plane; and
the first and second point planes are separated by a distance D1 that is at least 3 inches.

2. The softbox of claim 1 wherein:
the bottom plane and the first point plane are separated by a distance substantially equal to distance D1.

3. The softbox of claim 1 wherein:
the wall structure includes a first side wall and a second side wall opposite the first side wall;
the first point is at a first location on the first side wall;
the second point is at a second location on the first side wall;
a third point is at a first location on the second side wall and lies on the first point plane; and
a fourth point is at a second location on the second side wall and lies on the second point plane.

4. The softbox of claim 3 wherein:
a fifth point is at a third location on the first side wall and lies on the second point plane;
a sixth point is at a third location on the second side wall and lies on the second point plane;
the first point is positioned between the second and fifth points; and
the third point is positioned between the fourth and sixth points.

5. The softbox of claim 4 wherein:
the wall structure further includes a first end wall and a second end wall opposite the first end wall;
a seventh point is on the first end wall and lies on the second point plane; and
an eighth point is on the second end wall and lies on the second point plane.

6. The softbox of claim 1 wherein:
the wall structure includes a first side wall and a second side wall opposite the first side wall;
the perimeter along the first side wall lies on a curved surface; and
the perimeter along the second side wall lies on a curved surface.

7. The softbox of claim 6 wherein:
the perimeter along the first side wall lies on an arc that lies on a first circle;
the perimeter along the second side wall lies on an arc that lies on a second circle; and
the first and second circles have the same radius.

8. The softbox of claim 1 wherein:
the perimeter has a length D3 and a width D2; and
the ratio D3/D2 is >2.0.

9. The softbox of claim 2 wherein the distance D1 is at least 5 inches.

10. The softbox of claim 9 wherein the distance D1 is at least 7 inches.

11. The softbox of claim 1 further comprising a light diffuser screen that:
is supported to the housing;
includes an opening cover portion that covers at least most of the opening; and
diffuses light passing out through the opening cover portion.

12. A softbox comprising:
a frame having a first set of multiple elongated frame members;
a housing having: a bottom; wall structure extending from the bottom to a distal end; and an opening having a perimeter defined by the distal end of the wall structure;
a light mount that: includes a Bowens mount or the like; is supported to the bottom; is designed to attach to an associated light source;
a light diffuser screen that is supported to the housing and includes an opening cover portion that covers at least most of the opening;
wherein when the light diffuser screen is properly supported to the housing:
at least some of the elongated frame members of the first set: have ends that are supported to the Bowens mount or the like; extend distally along the housing wall structure; and support the housing wall structure to the Bowens mount or the like;
the opening cover portion of the light diffuser screen diffuses light passing out through the opening cover portion; and
the opening cover portion of the light diffuser screen has a curved shape.

13. The softbox of claim 12 wherein:
ends of at least some of the elongated frame members of the first set extend to the distal end of the wall structure.

14. The softbox of claim 12 wherein:
the curved shape is concave.

15. The softbox of claim 14 wherein:
the wall structure includes a first side wall and a second side wall opposite the first side wall;
the perimeter along the first side wall lies on an arc that lies on a first circle;
the perimeter along the second side wall lies on an arc that lies on a second circle; and
the first and second circles have the same radius.

16-17. (canceled)

18. The softbox of claim 12 wherein the housing is foldable.

19. The softbox of claim 12, wherein the frame includes:
multiple hinges that interconnect at least some of the elongated frame members of the first set and that are adapted to permit relative motion between the at least some of the elongated frame members of the first set; and
multiple clasps which support the at least some of the elongated frame members of the first set to the housing wall structure.

20. The softbox of claim 18 wherein:
a latching mechanism is selectively manually adjustable between a first condition that locks the housing in an open use position and a second condition that permits the housing to be folded.

21. The softbox of claim 20 wherein:
the latch post is supported to the Bowens mount or the like via support legs;
the frame includes a second set of multiple elongated frame members;
the latch post receiver is supported to ends of at least some of the elongated frame members of the second set;
the latch post receiver has an opening sized and shaped to receive the latch post; and
a latch post engagement device is selectively operable to engage the latch post to the latch post receiver.

22. The softbox of claim 21 wherein:
the latch post includes a latch post groove;
the latch post receiver includes a latch post engagement device operatively engaged to a quick-release button;
the latching mechanism is selectively adjustable between the first condition to the second condition by manually pressing the quick-release button to cause a surface of the latch post engagement device to come out of contact with the latch post groove, permitting the user to selectively separate the latch post receiver from the latch post.
